(19) United States
(12) Patent Application Publication
(10) Pub. No.: US 2007/0284064 A1
(43) Pub. Date: Dec. 13, 2007

(54) Slat Base for Window Blinds

(76) Inventor: Cheng-Chung LIU, City of Industry, CA (US)

Correspondence Address: LAW OFFICES OF J.F. LEE, 17800 CASTLETON STREET, SUITE 383, CITY OF INDUSTRY, CA, 91748, US

(21) Appl. No.: 11/381,969

(22) Filed: May 5, 2006

(51) Int. Cl. E06B 3/12

(52) U.S. Cl. 160/236

(57) ABSTRACT

Present invention provides an ingenious way to construct slat base for window blinds, enabling the addition of desired colors or patterns to be incorporated into the slat, by having channels along the length of a slat base, so that add-on materials of desired colors or patterns can be affixed to the slat surface to create desired decorative features.

### FIELD AND BACKGROUND OF THE INVENTION

The present invention relates generally to an improved design and construction of slat base for window blinds, allowing add-on materials of various patterns and colors to be incorporated into the surface of slats, enhancing the aesthetic value of window blinds.

Pull-up or roll-up window blinds have been in use for many years. The material used for the slats on these type of window blinds are mostly plastics, such as vinyl, PVC-based or other faux wood material, which are relatively inexpensive materials.

The universally limited color selection and lack of changing pattern on traditional blinds slats, however, has been a challenge to interior decoration industry since these blinds slats could not provide much decorative value into the interior design, coordination and/or matching.

In terms of interior design, windows (which oftentimes have associated window blinds) take up substantially amount of viewable area but has been traditionally forgotten due to the lack of affordable window blinds that provide such design or color flexibility in its construction.

Present invention provides an ingenious way to construct slat base for window blinds, enabling the addition of desired colors or patterns to be incorporated into the slat, enhancing the interior decoration of a house, office or any facility having such need.

### OBJECTS AND SUMMARY OF THE INVENTION

Present invention teaches the construction of slat base for window blinds, by creating channels along the length of a slat, so that add-on materials of desired colors or patterns can be affixed to the slat surface to create decorative features.

### DESCRIPTION OF THE DRAWINGS

The accompanying drawings, which are incorporated in and constitute a part of this specification, illustrate the preferred embodiments of the invention and together with the description, serve to explain the principles of the invention.

A brief description of the drawings is as follows:

FIG. 1 shows a first embodiment of present invention.

FIG. 2 shows a first embodiment of present invention having add-on materials affixed to the surface of a slat base.

FIG. 3 shows a second embodiment of present invention.

FIG. 4 shows a second embodiment of present invention having add-on materials affixed to the surface of a slat base.

### DETAILED DESCRIPTION OF THE PREFERRED EMBODIMENT

In accordance with stand blinds slat production process, a slat base is produced having four (4) ridges on one surface along the length of said slat, defining three (3) substantially equal channels along the length of said slat.

Depending on the variation for the means of production, a flat piece of slat may be produced first and then have the three (3) channels machined out.

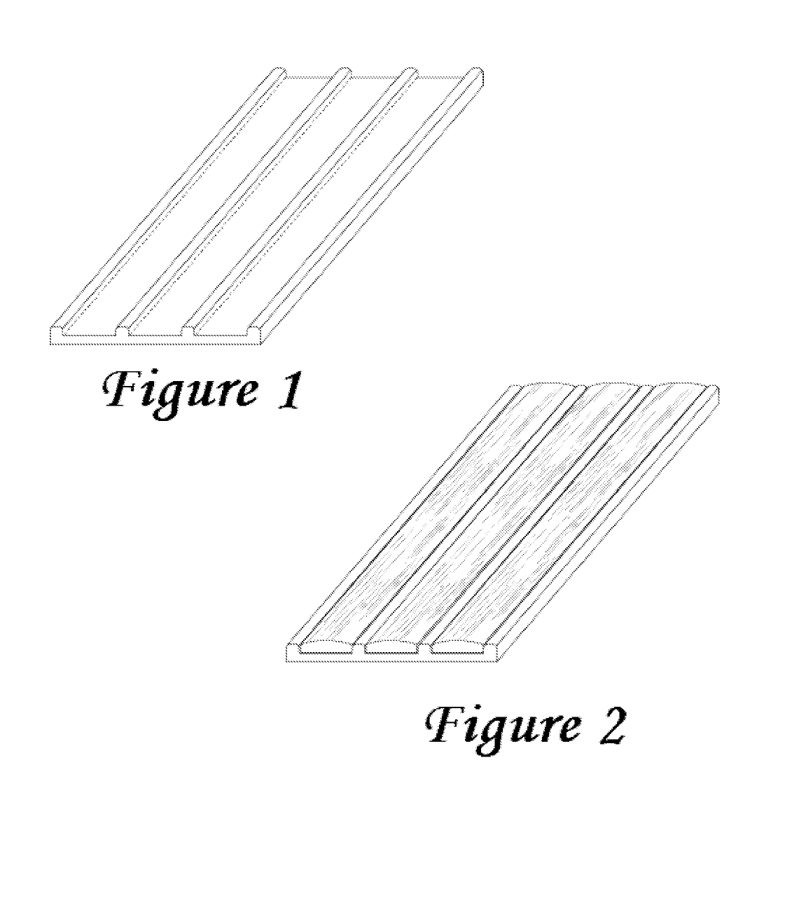

Present invention applies to whichever way of production stated above, as shown in FIGS. 1 and 2.

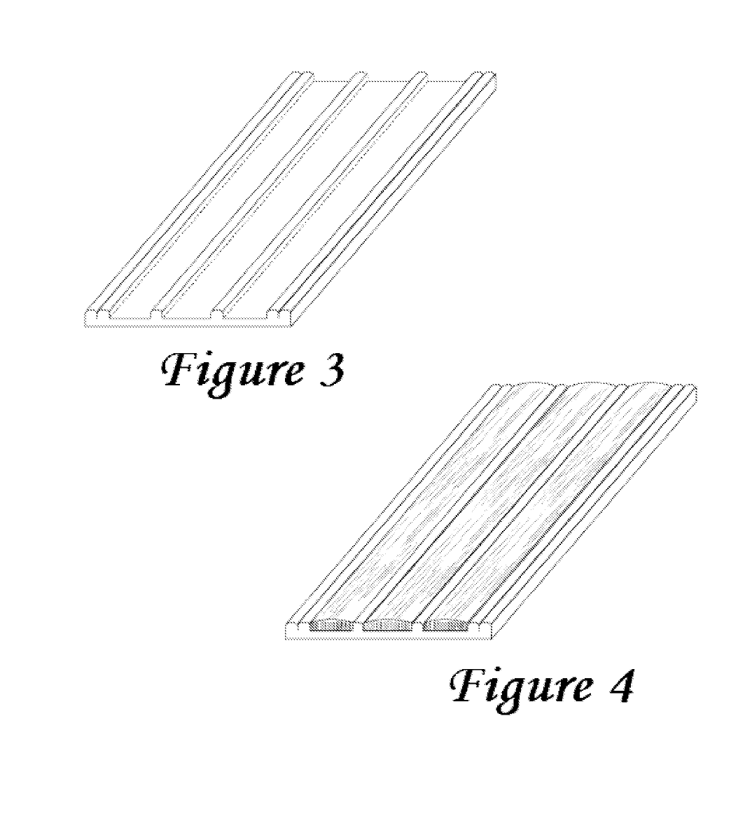

For alternative decorative feature, the two outermost ridges can be made into the form of two conjunctive double ridges, as shown in FIGS. 3 and 4.

Depending on industry needs, the construction of present invention can be made on both sides of a slat base, though the drawings in present only illustrate the embodiment on one side, the same principle can be applied to two-sided slat base construction by following the same disclosure herein.

Depending on industry needs, the construction of present invention can be made into 2-channel, 3-channel, or 4-channel slat base.

Although drawings in present invention illustrate the 3-channel embodiments, the construction of 2-channel or 4-channel slat base is no doubt similarly enabled by the disclosure contained herein and need no further illustration to any person reasonably skilled in the art.

What is claimed is:

1. Slat base for window blinds, comprising:
Three ridges along the length of, and on the first side of said slat base, defining two substantially equal channels for affixing add-on materials.

2. Slat base for window blinds of claim 1, further comprising three ridges on the second side of said slat base defining two substantially equal channels for affixing add-on materials.

3. Slat base for window blinds of claim 1, wherein the two outermost ridges are made up of conjunctive double ridges.

4. Slat base for window blinds, comprising:
Four ridges along the length of, and on the first side of said slat base, defining three substantially equal channels for affixing add-on materials.

5. Slat base for window blinds of claim 4, further comprising four ridges on the second side of said slat base defining three substantially equal channels for affixing add-on materials.

6. Slat base for window blinds of claim 4, wherein the two outermost ridges are made up of conjunctive double ridges.

7. Slat base for window blinds, comprising:
Five ridges along the length of, and on the first side of said slat base, defining four substantially equal channels for affixing add-on materials.

8. Slat base for window blinds of claim 7, further comprising five ridges on the second side of said slat base defining four substantially equal channels for affixing add-on materials.

9. Slat base for window blinds of claim 7, wherein the two outermost ridges are made up of conjunctive double ridges.
